(19) United States
(12) Patent Application Publication
(10) Pub. No.: US 2007/0268308 A1
(43) Pub. Date: Nov. 22, 2007

(54) METHOD, APPARATUS, AND COMPUTER PROGRAM PRODUCT FOR IMPLEMENTING DYNAMIC GRAPHICAL MODELING OF COMPUTER SYSTEMS

(76) Inventors: Jossie Maite McManus, Rochester, MN (US); Amanda Meemken, Clearwater, MN (US); Cale T. Rath, Byron, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/383,766

(22) Filed: May 17, 2006

(51) Int. Cl. G09G 5/00

(52) U.S. Cl. 345/619

(57) ABSTRACT

A method, apparatus and computer program product for implementing dynamic modeling for dynamic computer systems includes a system description file for a computer system that is stored and updated to include changed information for the computer system. The system description file contains information regarding system hardware components and respective component locations for the system hardware components within the computer system. A default system enclosure graphic image file contains location information for system hardware components. A combination of images is provided programmatically and grouped within a default system enclosure graphic image as defined sub-elements. With this grouping, a system graphic image file is dynamically updated to reflect hardware changes from the system description file for the computer system.

### FIELD OF THE INVENTION

The present invention relates generally to the data processing field, and more particularly, relates to a method, apparatus and computer program product for implementing dynamic graphical modeling for computer systems.

### DESCRIPTION OF THE RELATED ART

Currently, arrangements exist to graphically represent a system using static image files. As these systems need to display additional componentry, all sub-components can be combined to the original image. This combination is done to a static image file by either manually editing the static image file or using a graphics tool to include new shapes.

However, when this combination occurs the image of a system and all its sub-components contains no information regarding what the sub-component is or its location with respect to the larger system. This also increases the size of the image file significantly since the image file is a combination of several images into one.

There exists a schema for an Extensible Markup Language (XML) file that describes the make up of one or multiple computer server systems. There also exists the ability to make images of these computer components. However, there is no link between the two.

A need exists for an effective mechanism for implementing dynamic modeling for dynamic computer systems.

As used in the following description and claims, it should be understood that the term graphic image file includes a scalable vector graphic (SVG) and various arrangements of graphical data and vector graphical data.

### SUMMARY OF THE INVENTION

Principal aspects of the present invention are to provide a method, apparatus and computer program product for implementing dynamic modeling for dynamic computer systems. Other important aspects of the present invention are to provide such a method, apparatus and computer program product for implementing dynamic modeling for dynamic computer systems substantially without negative effect and that overcome many of the disadvantages of prior art arrangements.

In brief, a method, apparatus and computer program product are provided for implementing dynamic modeling for dynamic computer systems. A system description file for a computer system is stored and updated to include changed hardware information for the computer system. The system description file contains information regarding system hardware components and respective component locations for the system hardware components within the computer system. A default system enclosure graphic image file contains location information for system hardware components. A combination of images is provided programmatically and grouped as defined sub-elements within a default system enclosure graphic image. With this grouping, a system graphic image file is dynamically updated to reflect hardware changes from the system description file for the computer system.

In accordance with features of the invention, in providing the combination of images programmatically, vital product data (VPD) and graphic image information are collected. The graphic image files for the computer system components are combined to create the system graphic image file or computer system model for the computer system.

In accordance with features of the invention, a plurality of graphic image files, such as a plurality of scalable vector graphics (SVGs) is stored for computer system components. Each graphic image file provides a graphical representation for a respective computer system component and can include textual information about the component. Graphic image files are collected and a visual representation of the computer system is generated.

In accordance with features of the invention, the system description file is an Extensible Markup Language (XML) description file that contains an identification code, such as a part number, for a graphic image file representing a computer system component and a location code for the computer system component.

In accordance with features of the invention, the default system enclosure graphic image file stores location information for system hardware components. The location information is used to link a graphic image of a computer system component from the system description file.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1 and 2 are block diagram representations illustrating an exemplary computer system and operating system for implementing dynamic graphical modeling methods for computer systems in accordance with the preferred embodiment;

FIGS. 3, and 4 are flow charts illustrating exemplary steps of methods for implementing dynamic modeling for dynamic computer systems in accordance with the preferred embodiments;

FIG. 5 illustrates an exemplary method for implementing dynamic modeling for an exemplary computer system in accordance with the preferred embodiment;

FIG. 6 is a block diagram illustrating a computer program product in accordance with the preferred embodiment.

### DETAILED DESCRIPTION OF THE PREFERRED EMBODIMENTS

In accordance with features of the preferred embodiments, methods are provided using dynamic graphical modeling to model computer systems. The current way to model computer systems involves the use of static images to model a dynamic system. Currently many graphics are large in file size. To model a computer/server system with these is cumbersome.

In accordance with features of the preferred embodiments, using graphic image files, such as scalable vector graphics (SVGs), to implement dynamic image changes reduces file size and adds several other benefits including scalability, reusability, and element grouping.

In accordance with features of the preferred embodiments, graphics that contain knowledge of computer system componentry are created and advantageously are dynamically altered to model a unique computer system described within an XML description file. This XML description file contains information regarding system hardware and system hardware location relative to the larger system. The larger system is defined in a default system enclosure SVG. The default system enclosure SVG contains location information used to link a corresponding SVG to a component described in the XML description file. The combination of these images is done programmatically and grouped as defined sub-elements within an image of a default system enclosure graphic. As a result of this grouping, the system graphic image file is dynamically updated to reflect hardware changes from the system XML description file.

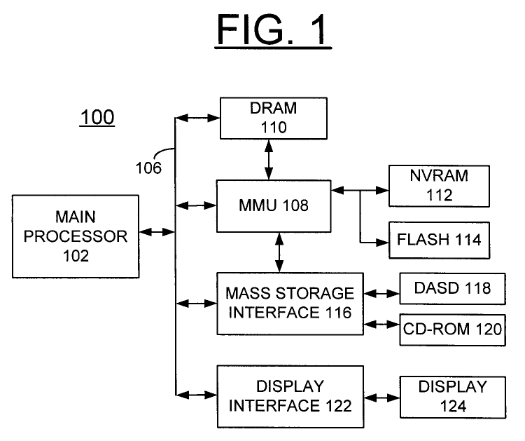

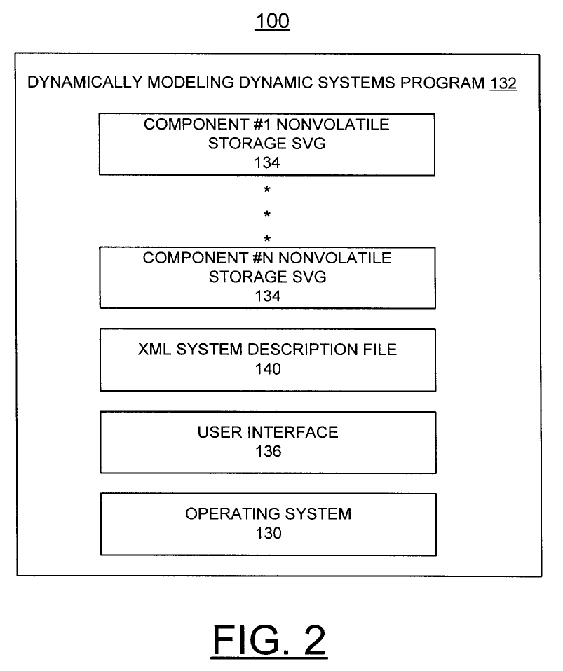

Having reference now to the drawings, in FIGS. 1 and 2, there is shown an exemplary computer system generally designated by the reference character 100 for implementing dynamic modeling methods for computer systems in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 2, computer system 100 includes an operating system 130, a dynamic modeling dynamic systems program 132, for each component #1-#N a nonvolatile storage scalable vector graphic (SVG) 134 in accordance with the preferred embodiment, and a user interface 136. An Extensible Markup Language (XML) system description file 140 of the preferred embodiment is stored and dynamically updated in accordance with the methods of the preferred embodiment.

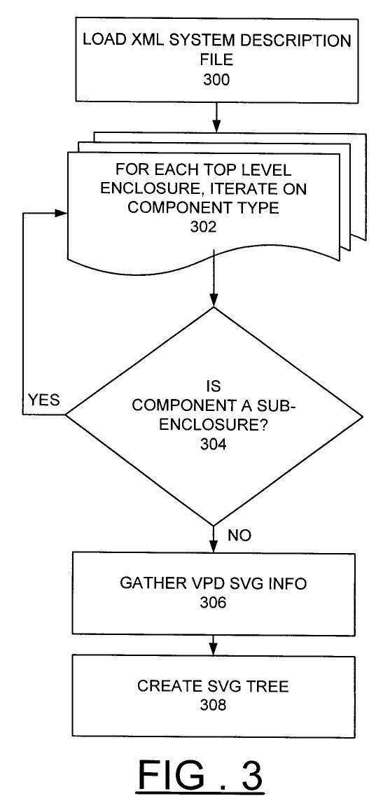

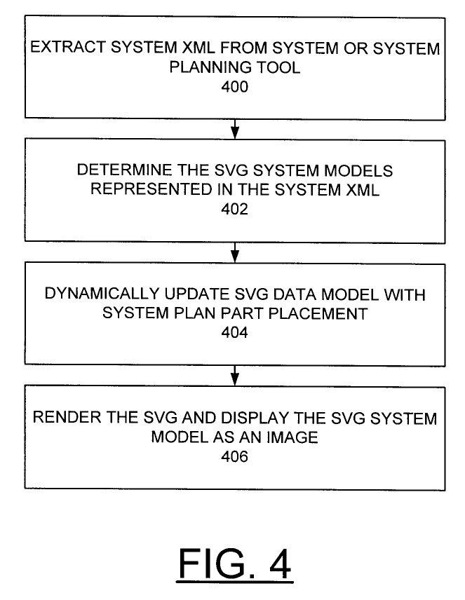

Various commercially available computers can be used for computer system 100, for example, an IBM computer. CPU 102 is suitably programmed by the dynamic modeling dynamic systems program 132 to execute the flowchart of FIGS. 3 and 4 for implementing dynamic modeling methods for computer systems in accordance with the preferred embodiment.

In accordance with features of the preferred embodiments, in order to make dynamic changes to an actual graphic image file or SVG, the XML description file 140 does not need to contain any information as to the shape or functionality of the component. XML description file 140 needs to only contain identification, such as, a part number or name of the graphic image file representing a particular sub-component and its location code. This location code provides information such as system, rack, backplane, and slot. Having this information enables rendering graphical images at defined locations within a default system enclosure SVG. Each slot within the default system enclosure SVG that can house a replaceable part is put in a group within the default system enclosure SVG or default system enclosure graphical image. This group is identified by the location code that it is representing. As a default enclosure image, this group will reference a dummy component. The XML description file 140 specifies what component is to replace this dummy part. The location code in the XML description file 140 matches an ID for the group that represents that location. Then, rather than adding the image by placing it on top, it will actually replace the dummy image that is being referenced. The replacement not only changes the graphics of the modeled system, but also will continue to maintain textual information about the part and the location code to which the part belongs. So in result, the default system enclosure SVG or system graphical image will contain system structure knowledge. When a change occurs in the XML description file 140 changes in the model can be made quickly and easily, involving no manual changes to the images.

Being able to reference system component images makes this image creation more extensible. In addition, not referencing these components and making changes dynamically would cause the files, even in SVG, to be large. Another advantage of using graphic image files is their ability to rotate and scale the image. For example if system A and system B use the same Ethernet card this one image can be used for both systems even if the location of the card differs. For example the slot direction may also change from vertical to horizontal, or from horizontal to vertical and the like.

Referring now to FIG. 3, there are shown exemplary steps of methods for implementing dynamic modeling for dynamic computer systems in accordance with the preferred embodiment starting at a block 300 with the XML description file 140 being loaded. Then for each top-level enclosure (TLE), iterating on each component type is performed as indicated in a block 302 and checking is performed to determine if component is a sub-enclosure as indicated in a decision block 304. If the component is a sub-enclosure, then iterating on each component type is performed at block 302. Next vital product data (VPD) and graphical image or SVG information are collected as indicated in a block 306. The graphic image files or SVGs for the computer system components are combined to create a system graphical image or computer system model for the computer system as indicated in a block 308.

Referring now to FIG. 4, there are shown exemplary steps of methods for dynamic modeling for dynamic computer systems in accordance with the preferred embodiment starting at a block 400 with extracting the system XML description file 140 from the system 100 or a system planning tool. Then the graphical image system models represented in the system XML description file 140 are determined as indicated in a block 402. Next the graphical image or SVG data model is dynamically updated with system plan part placement as indicated in a block 404. The system graphic image data model is rendered and the system graphical image or SVG system model is displayed as an image as indicated in a block 406.

As a consumer of this product, no knowledge of the system or its components is necessary. As long as one has the XML description file 140, any changes made to the XML description file 140 will also be reflected graphically. Being that humans are visual learners, this graphical view becomes particularly useful in reports regarding the purchase and maintenance of a system. For example, when a part fails in system we would have the capability to highlight, or even flash, the failed part thus showing the consumer visually where their failed part is and how to take care of the problem. If perhaps a card has mistakenly been placed in the incorrect slot, the image can highlight both the component and the correct slot.

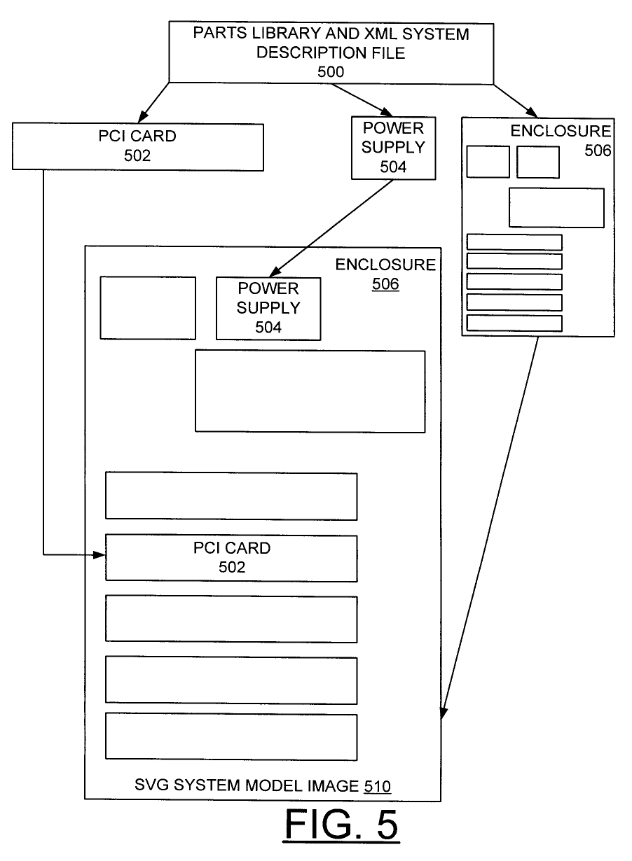

FIG. 5 provides an example of implementing dynamic modeling for a dynamic computer system. As shown, a parts library and XML description file 140 are loaded as indicated in a block 500. A plurality of respective graphical imaged or SVG images are obtained as indicated PCI CARD 502, POWER SUPPLY 504, and ENCLOSURE 506. The graphical image of the enclosure 506 is altered to show the inclusion of the PCI card 502 and the power supply 504 to define a system graphical image or SVG SYSTEM MODEL IMAGE 508.

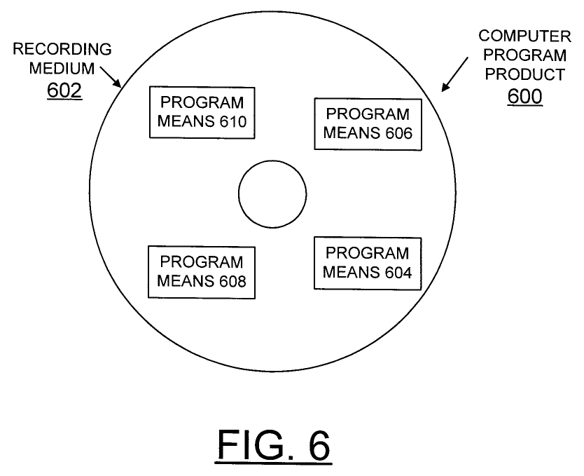

Referring now to FIG. 6, an article of manufacture or a computer program product 600 of the invention is illustrated. The computer program product 600 includes a recording medium 602, such as, a floppy disk, a high capacity read only memory in the form of an optically read compact disk or CD-ROM, a tape, a transmission type media such as a digital or analog communications link, or a similar computer program product. Recording medium 602 stores program means 604, 606, 608, 610 on the medium 602 for carrying out the methods for implementing dynamic modeling for dynamic computer systems of the preferred embodiment in the system 100 of FIG. 1.

A sequence of program instructions or a logical assembly of one or more interrelated modules defined by the recorded program means 604, 606, 608, 610, direct the computer system 100 for implementing dynamic modeling methods for dynamic computer systems of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing dynamic modeling for a dynamic computer system comprising:
providing a system description file for a computer system; said system description file contains information regarding system hardware components and respective component locations for the system hardware components within the computer system;
updating said system description file to include changed information for the computer system;
providing a default system enclosure graphic image file containing location information for system hardware components; and
providing a combination of images programmatically and grouping said combination of images as defined sub-elements within a default system enclosure graphic image to define a system graphic image file; said system graphic image file being dynamically updated to reflect the changed information from the system description file.

2. A method for implementing dynamic modeling for a dynamic computer system as recited in claim 1 includes storing a plurality of graphic image files for computer system components.

3. A method for implementing dynamic modeling for a dynamic computer system as recited in claim 2 wherein said plurality of graphic image files include scalable vector graphics (SVGs) and providing the combination of images programmatically includes collecting vital product data (VPD) and SVG information.

4. A method for implementing dynamic modeling for a dynamic computer system as recited in claim 3 further includes combining SVGs for the computer system components to create the system SVG file or computer system model for the computer system.

5. A method for implementing dynamic modeling for a dynamic computer system as recited in claim 3 wherein each SVG provides a graphical representation for a respective computer system component and includes textual information about the component.

6. A method for implementing dynamic modeling for a dynamic computer system as recited in claim 5 further includes collecting said SVGs to generate a visual representation of the computer system.

7. A method for implementing dynamic modeling for a dynamic computer system as recited in claim 1 wherein providing said system description file for the computer system includes providing an Extensible Markup Language (XML) description file for the computer system.

8. A method for implementing dynamic modeling for a dynamic computer system as recited in claim 7 includes providing said Extensible Markup Language (XML) description file for the computer system containing an identification of an graphical image file representing a computer system component and a location code for the computer system component.

9. A computer program product for implementing dynamic computer system modeling in a computer system, said computer program product including instructions executed by the computer system to cause the computer system to perform:
providing a system description file for a computer system; said system description file contains information regarding system hardware components and respective component locations for the system hardware components within the computer system;
updating said system description file to include changed information for the computer system;
providing a default system enclosure graphic image file containing location information for system hardware components; and
providing a combination of images programmatically and grouping said combination of images as defined sub-elements within a default system enclosure graphic image to define a system graphic image file; said system graphic image file being dynamically updated to reflect the changed information from the system description file.

10. A computer program product for implementing dynamic computer system modeling as recited in claim 9 further includes storing a plurality of scalable vector graphics (SVGs) for computer system components.

11. A computer program product for implementing dynamic computer system modeling as recited in claim 10 wherein providing the combination of images programmatically includes collecting vital product data (VPD) and SVG information.

12. A computer program product for implementing dynamic computer system modeling as recited in claim 11 further includes combining SVGs for the computer system components to create the system SVG file or computer system model for the computer system.

13. A computer program product for implementing dynamic computer system modeling as recited in claim 10 wherein each SVG provides a graphical representation for a respective computer system component and includes textual information about the component.

14. A computer program product for implementing dynamic computer system modeling as recited in claim 13 further includes collecting said SVGs to generate a visual representation of the computer system.

15. A computer program product for implementing dynamic computer system modeling as recited in claim 9 wherein providing said system description file for the computer system includes providing an Extensible Markup Language (XML) description file for the computer system.

16. A computer program product for implementing dynamic computer system modeling as recited in claim 15 includes providing said Extensible Markup Language (XML) description file containing a name of an SVG representing a computer system component and a location code for the computer system component.

17. Apparatus for implementing dynamic modeling for a dynamic computer system comprising:
a system description file for a computer system; said system description file contains information regarding system hardware components and respective component locations for the system hardware components within the computer system;
said system description file being updated to include changed hardware information for the computer system;
a default system enclosure graphic image file containing location information for system hardware components; and
a dynamically modeling dynamic systems program for providing a combination of images programmatically and grouping said combination of images as defined sub-elements within a default system enclosure graphic image to define a system graphic image file; said system graphic image file being dynamically updated to reflect the changed information from the system description file.

18. Apparatus for implementing dynamic modeling for a dynamic computer system as recited in claim 17 includes non-volatile storage storing a plurality of graphical image files for computer system components.

19. Apparatus for implementing dynamic modeling for a dynamic computer system as recited in claim 18 wherein said plurality of graphical image files include scalable vector graphics (SVGs), each graphical image file provides a graphical representation for a respective computer system component and includes textual information about the component.

20. Apparatus for implementing dynamic modeling for a dynamic computer system as recited in claim 17 wherein said system description file for the computer system includes an Extensible Markup Language (XML) description file for the computer system; said XML description file containing an identification of a graphical image file representing a computer system component and a location code for the computer system component.
